(19) United States
(12) Patent Application Publication
(10) Pub. No.: US 2005/0160997 A1
(43) Pub. Date: Jul. 28, 2005

(54) Fast absorption animal litter and method for making same

(76) Inventor: William R. Weaver, Pine Bluff, AR (US)

Correspondence Address: J. Charles Dougherty;Wright, Lindsey & Jennings LLP, Suite 2200, 200 West Capitol Avenue, Little Rock, AR, 72201, US

(21) Appl. No.: 10/935,580

(22) Filed: Sep. 7, 2004

Related U.S. Application Data
(60) Provisional application No. 60/539,229, filed on Jan. 26, 2004.
(60) Provisional application No. 60/539,216, filed on Jan. 26, 2004.

(51) Int. Cl. A01K 1/015

(52) U.S. Cl. 119/171

(57) ABSTRACT

A fast-absorption animal litter comprises an organic material and a surfactant, the two products being uniformly mixed and formed into a pellet. The organic material is preferably yellow pine wood fiber. The product quickly absorbs moisture in a litter pan allows the litter pan to remain drier and to be refilled less frequently. The pellets may be left intact to limit tracking of the material, or may be crumbled for a softer texture. In the process for forming the material, crumbled pellets are screened to separate fines and dust, which are returned for re-pelletizing.

This application claims the benefit of U.S. provisional patent application No. 60/539,229 entitled “Clumping Pine Wood Cat Litter” and filed on Jan. 26, 2004 by inventor William R. Weaver, and U.S. provisional patent application No. 60/539,216, entitled “Fast Absorption Animal Litter” and also filed on Jan. 26, 2004 by William R. Weaver.

### BACKGROUND OF THE INVENTION

The present invention relates to animal litters, and in particular to animal litters that are based on organic materials and are designed to absorb liquids quickly.

Various clays (especially bentonite) have been used as a base material for animal litters for some time. These materials become tacky when wetted, thereby forming a “clump” that is easily removed from the remainder of the litter for purposes of cleaning. It has been recognized, however, that a litter based on organic materials rather than clays would be highly desirable. Organic materials, such as sawdust and lumber mill scraps, are readily available and inexpensive. They are also absorbent and can be formed into pellet form using a pellet mill; such mills have long been used in the manufacture of animal feed. Further, some woods, particularly pine, contain resins that act as natural deodorizers.

The prior art includes a number of attempts to develop cellulosic materials in the manufacture of animal litter, and in particular the use of wood particles. For example, U.S. Pat. No. 3,941,090 to Fry teaches a cedar-based animal litter with an alfalfa binding agent. U.S. Pat. No. 4,258,659 to Rowell teaches a cat litter comprising soft wood particles formed from waste wood material, including sawdust and wood pieces, collected from sawmills. U.S. Pat. No. 5,044,324 to Morgan et al. teaches the manufacture of wood fiber “crumbles” that may be used as animal litter; the crumbles are formed from the grinding of pelletized wood fiber. U.S. Pat. No. 5,271,355 teaches the combination of ground wood chips and peat to form animal litter.

The prior art also includes a number of attempts to develop litters based on a combination of organic materials and other ingredients; for example, U.S. Pat. No. 5,970,916 to Yoder et al. teaches a litter material composed of a cellulosic substrate with a first outer layer of xanthan gum and a second outer layer of guar gum. Also, U.S. patent application Publication No. 2002/0038633 to Hayakawa teaches a high-viscosity cellulose ether as a binder that is responsible for a clumping action in a litter composed partially of organic material and partially of inorganic materials such as clays. The use of various gums, including guar gum, and carboxymethylcellulose (CMC) are known in the manufacture of animal litters. U.S. Pat. No. 5,664,523 to Ochi et al. teaches a base litter material that includes both organic and inorganic components, but also includes 15-55% guar gum by weight. U.S. Pat. No. 6,053,125 to Kory et al. teaches a clumpable cat litter formed of corncob grit and components that are coated with guar gum. U.S. Pat. No. 6,089,189 to Goss et al. teaches a cellulose-based litter product wherein cellulosic granules are treated with an adhesive and mixed with a particulate polymeric clumping agent, preferably guar or locust bean gum.

An important limitation of litters formed of organic materials, and of litters in general, is the time required to absorb liquid. Although litters formed of organic materials, such as wood pellets, are highly absorbent, they may require 30 to 60 seconds of contact before such pellets begin to absorb liquid. Another 60 to 90 seconds may be required before full absorption is reached. This absorption rate is too slow for use in animal litter, since much of the animal urine deposited by an animal into a litter box will simply flow to the bottom of the box rather than be absorbed. The pooling of urine at the bottom of a litter box will cause odors and may increase the growth of bacteria, both circumstances requiring the litter box to be changed more often. Frequent changing of the litter box is wasteful of litter and time-consuming for the animal owner. A fast-absorbing, organic-based animal litter is thus desired.

### BRIEF SUMMARY OF THE INVENTION

The present invention is directed to an animal litter (which includes products described as animal “bedding”) composed primarily of an organic absorbent material, preferably wood fiber, with the addition of a nonionic surfactant to increase the liquid absorption rate of the litter. The quick absorption aspect of the invention reduces the potential for odors and bacterial growth in the litter pan, and provides a much healthier environment for animals using the litter.

The wood fiber component of the invention preferably constitutes 97-99% of the product by total weight. The use of a high percentage of wood fiber reduces the manufacturing cost of the product, since wood fiber is a surplus material from lumber mills, paper mills, and the like and may be obtained at very low cost. The surfactant preferably comprises the reminder of the product weight. Several surfactants may be used according to various embodiments of the invention.

Unlike prior art materials that comprise a substrate and a coating, the present invention utilizes a mix of the base organic material and surfactant throughout the pelletized product. No separate coating is used, thereby reducing the manufacturing cost of the product.

The present invention is formed from natural organic materials, which are non-toxic and fully biodegradable. The material may thus may be disposed of in any standard manner, or even used as compost. The material is flushable, and because of its re-wetting action and rapid absorption rate may be flushed immediately upon deposit in the toilet. The natural organic materials also provide the advantage of natural odor neutralizers found in the material itself.

The present invention also comprises a method of manufacturing the animal litter. Wood fiber is purchased as waste from the lumber or paper industry. The material is metered with the surfactant by weight, and mixed as the mill grinds the wood fibers to a consistent size. The mixture is then pelletized, and the resulting pellets are cooled before crumbling.

It is therefore an object of the present invention to provide for a fast-absorption animal litter based on low-cost organic materials including a surfactant.

It is a further object of the present invention to provide for a litter that is biodegradable.

It is also an object of the present invention to provide for a litter that is flushable without any required wait before flushing.

It is also an object of the present invention to provide for a litter that includes natural deodorizers.

It is also an object of the present invention to provide for a litter that does not require the use of clays or other inorganic base materials.

It is also an object of the present invention to provide for a litter that has a surfactant mixed throughout the litter pellets rather than present in a separate coating on the outside of the pellets.

These and other features, objects and advantages of the present invention will become better understood from a consideration of the following detailed description of the preferred embodiments and appended claims in conjunction with the drawing as described following:

### BRIEF DESCRIPTION OF THE DRAWING

FIG. 1 is a flow chart describing a process for manufacturing animal litter according to a preferred embodiment of the present invention.

### DETAILED DESCRIPTION OF THE INVENTION

A preferred embodiment of the present invention may now be described. The preferred embodiment is formed of two constituent components: yellow pine wood fiber and a nonionic surfactant. Yellow pine is a commonly used lumber and pulpwood material, and lumber mill scraps are available for use in the production of litter at low cost. The yellow pine is preferably purchased as a kiln dried material, but will be in various sizes including sawdust, shavings, or a mix of these two.

The purpose of the non-ionic surfactant is to increase the rate of moisture absorption. This trait also improves the odor control exhibited by the product, since urine is quickly absorbed into the litter and odor is trapped within. Several surfactants may be used in alternative embodiments of the invention. These surfactants include T-Det N9 or T-Det NP9 from Harcros Chemicals; Standapol WAQ-LC from the Cognis Corporation; and Wickit 1362 by Hercules Corporation. The absorption rates of each of these surfadtants are quite close to one another, and any may be used with the present invention with success. Alternative embodiments may comprise a combination of two or more surfactant formulations based on availability and cost considerations.

The product's two components listed above are formed into a pellet using a pellet mill. The size of the pellets desired depends upon the application for which the material is to be manufactured. For example, it has been found that the best pellet diameter for cat litter and small animal bedding is in the range of 0.1875 inches to 0.250 inches. The pellets can be retained whole to limit tracking by the animal from the litter pan, or may be crumbled and screened for a software texture and thus greater animal comfort. In the case of equine bedding, a pellet of a diameter of 0.250 inches is preferred, with a more course crumbling than may be applied to pellets used for small animal litter or bedding. In any case, the pellets formed are preferably of a length ranging from 0.250 to 1.000 inches. The preferred bulk density of the product is over 40 pounds per cubic foot. The preferred total moisture content of the product is less than 8% of the product's total weight.

Tests conducted by the inventor demonstrate the improved absorption qualities of wood fiber pellets that include a surfactant such as those listed above. In these tests, untreated pine wood fiber pellets were shown to begin to absorb moisture within 30 to 60 seconds after contact. The pellets continue to wick and absorb liquid until completely hydrated, which required contact times of an additional 60 to 90 seconds. The addition of 1% by total product weight of a surfactant dramatically improves the performance of the wood pellets; absorption begins within 5 to 6 seconds of moisture contact, and full hydration is reached within 30 seconds. Incremental improvements are reached with additional amounts of surfactant, such that with 2% surfactant the product will start to absorb moisture within 3 seconds after contact, with 4% surfactant the product will start to absorb moisture within 2 seconds after contact, and with 8% surfactant the product will start to absorb moisture within 2 second after contact. In each of the tests with 2%, 4%, and 8% surfactant, total hydration was reached in less than 30 seconds.

Due to the high cost of the surfactants, the use of large percentages of surfactant in the product would drive the litter manufacturing cost so high that the product would no longer be feasible to produce. Thus in the preferred embodiment, the product contains 3% or less of surfactant by weight, although percentages of surfactant up to about 5% by weight may be employed for various embodiments and still fall within the economic limits set by the market for such products.

An additional benefit of the high rate of absorption in the preferred embodiment is that the high absorption rate causes pellets to break down more quickly in the presence of moisture. The swollen wood fibers begin to “fluff” when this occurs. The fluffing action allows liquid to evaporate more quickly from the pellets, which improves the absorption ability, and thus the overall performance, of the litter. The litter box will be drier overall, and the litter will last longer between required changings.

The animal litter formed according to the preferred embodiment is made entirely from non-toxic products and is fully biodegradable. It may thus be disposed of in any conventional and convenient manner without concern about harm to the environment. The product does not form clumps like clay- and treated grain-based litters, and thus will not adhere to the litter pan. The product may be flushed without a pre-soaking period in order to empty the litter box for fresh litter.

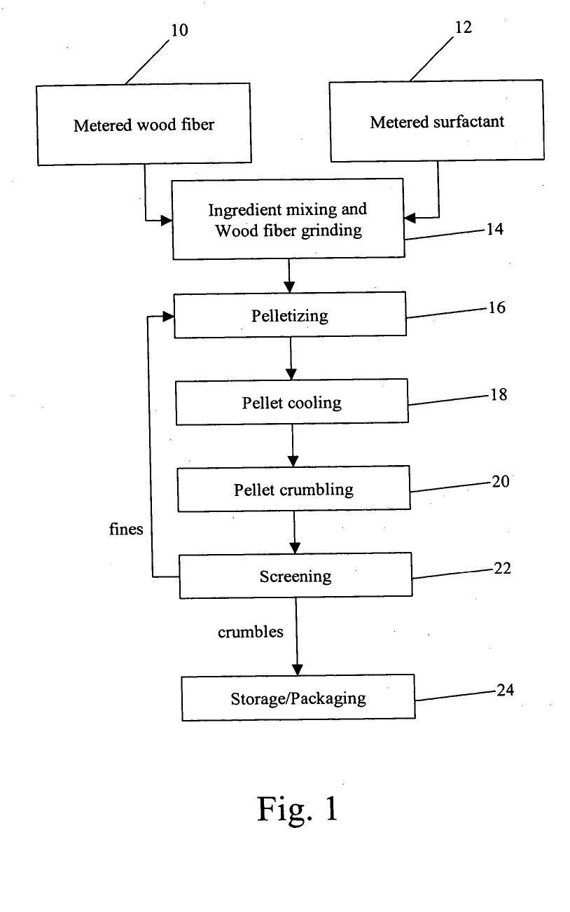

Now with reference to FIG. 1, the preferred embodiment of the present invention for producing the animal litter as described above may be described. At step 10, wood fiber is metered by weight into the production facility. Surfactant is metered by weight at step 12. The wood fiber and surfactant are brought together at step 14, where the wood fiber is ground to a uniform fiber consistency. The grinding action results in the mixing of the wood fiber and surfactant, such that a uniform mixture of the materials may result. It should be noted that while the metering of surfactant is shown as a single step 12, multiple surfactants may be mixed and metered either together or separately. In various embodiments, there may be only one material used for the surfactant, or various materials may be used together in a mixture to form the surfactant. In alternative embodiments, the grinding and mixing steps may be performed separately.

Material is moved from a holding bin above the pellet mill into the mill itself at pelletizing step 16. In step 16, pellets of material are formed by extrusion. Due to the thorough mixing at step 14, the resulting pellets will have a uniform distribution of each material throughout their volume. The extrusion process in the pellet mill generates significant heat, and the resulting pellets are quite hot. The pellets are thus transported, by conveyor or other means, to a cooling step at block 18. Once cooled, the pellets are optionally crumbled at block 20, preferably using an adjustable, dual-roller pellet crumbling mechanism.

As pellets pass between the tightly-spaced rollers of such a device, the pellets are broken into smaller pieces, but they are not ground into a dust. Alternative embodiments may not include the crumbling step.

In cases where crumbling step 20 is performed, such step results in both pellet crumbles and some fine, dusty material. The screening step at block 22 is used to separate the crumbles from the fines. The fines are returned to the pelletizing step at block 16 for reuse in the formation of pellets. The finished crumbles (or pellets) are passed to step 24, which may include storage as an intermediate step and eventual packaging for shipment to distribution points.

The present invention has been described with reference to certain preferred and alternative embodiments that are intended: to be exemplary only and not limiting to the full scope of the present invention as set forth in the appended claims.

1. An animal litter comprising an organic base material and a surfactant, wherein said litter is formed of granules, and said organic base material and said surfactant are distributed approximately evenly throughout said granules.

2. The animal litter of claim 1, wherein said organic base material is wood fiber.

3. The animal litter of claim 2, wherein said organic base material is pine wood fiber.

4. The animal litter of claim 3, wherein said litter is composed of 95% to 99% wood fiber by total product weight.

5. The animal litter of claim 4, wherein said litter is composed of 1% to 5% surfactant by total product weight.

6. The animal litter of claim 1, wherein said granules are pellets.

7. The animal litter of claim 6, wherein a diameter of said pellets is in the range of about 0.1875 inches to 0.250 inches.

8. The animal litter of claim 1, wherein said granules are crumbled pellets.

9. A process for manufacturing an animal litter, comprising the steps of:
(a) grinding a wood material such that said wood material is reduced to wood fibers;
(b) mixing the fibers and a surfactant to form an approximately uniform mixture;
(c) pelletizing said mixture to form pellets, wherein the pellets comprise a uniform mixture of the fibers and the surfactant throughout the pellets; and
(d) cooling the pellets.

10. The process of claim 9; further comprising the step of metering the wood material and the surfactant prior to said mixing step.

11. The process of claim 9, further comprising the step of collecting the mixture in a holding bin prior to said pelletizing step.

12. The process of claim 9, wherein said grinding and mixing steps occur simultaneously.

13. The process of claim 9, wherein the pellets comprise a diameter in the range of about 0.1875 inches to 0.250 inches.

14. The process of claim 9, further comprising the step of crumbling the pellets.

15. The process of claim 14, further comprising the step of metering the wood material and the surfactant prior to said mixing step.

16. The process of claim 14, further comprising the step of screening the pellets to separate crumbled pellets from fines, and returning any fines to said pelletizing step.

17. The process of claim 14, further comprising the step of collecting the mixture in a holding bin prior to said pelletizing step.

18. The process of claim 14, wherein said grinding and mixing steps occur simultaneously.

19. The process of claim 14, wherein prior to said crumbling step the pellets comprise a diameter in the range of about 0.1875 inches to 0.250 inches.
